(19) United States
(12) Patent Application Publication
(10) Pub. No.: US 2002/0006246 A1
(43) Pub. Date: Jan. 17, 2002

(54) Packaged integrated optical components

(76) Inventors: Malcolm Rory Green, The Old Stables (GB); Pisu Jiang, 3 Templars Close (GB)

Correspondence Address: W DOUGLAS CAROTHERS JR, COUNEL INTELLECTUAL PROPERTY, 80 ROSE ORCHARD WAY, SAN JOSE, CA, 95134

(21) Appl. No.: 09/775,026

(22) Filed: Jan. 31, 2001

(30) Foreign Application Priority Data
Feb. 1, 2000 (GB) 00 02276.4

(51) Int. Cl. G02B 6/12

(52) U.S. Cl. 385/14

(57) ABSTRACT

A packaged integrated optical component comprises a substrate or chip housed in the package and having an optical waveguide within which an optical signal propagates. A photodetector disposed relative to the waveguide collects light that leaks from the optical waveguide and scattered into the substrate. In particular, the photodetector is disposed below the substrate waveguide or below a plane of a lower surface of the substrate so that its field of detection for scattered light in the substrate is sufficiently enhanced to provide for successful optical signal monitoring.

### REFERENCE TO RELATED APPLICATION

This application claims priority benefits of prior filed co-pending British patent application No. 00 02276.4, filed Feb. 1, 2000, entitled, INTEGRATED OPTICAL COMPONENTS, and is incorporated herein by reference thereto.

### FIELD OF THE INVENTION

This invention relates to a packaged integrated optical component and in particular to such a component having an optical waveguide formed in a substrate, mounted within a package.

### BACKGROUND OF THE INVENTION

The manufacture of integrated optical components intended for use in the telecommunications industry for the transmission of data with optical signals is known. A typical manufacturing technique for such a component employs a lithium niobate substrate cut from a wafer, which substrate is also referred to as a chip. An optical waveguide of a required configuration may be formed in the substrate such as by a selective titanium diffusion process. The substrate is then processed in a manner to provide it with the required operating characteristics. For example, an electrode structure may be formed on the surface of the substrate, spatially with the longitudinal extent of the formed optical waveguide so that electrical signals supplied to the electrode structure may influence the propagation and characteristics of an optical signal along the waveguide. The substrate is then mounted in a package appropriate with input and output optical and electrical connections providing for signal coupling and controlling of the operation of the component. The packaged component may, then, be deployed within a communication system.

During operation of the communication system, it is usually desired to monitor the effect the optical component is having on the optical signal propagating through the component and to adjust the operating parameters for the optical component to bring the output signal of the component to within a required range of operation for that component. See, for example, U.S. Pat. No. 5,259,044 and the article of Y. Kubota et al., entitled “10 Gb/s Ti:LiNbO3 Mach-Zehnder Modulator with Built-in Monitor Photo-diode Chip”, ECOC 97, pp. 167-170, Sep. 22-27, 1997. For this purpose, the optical signal may be monitored externally of the component, or a portion of the optical signal may be led out of the component, for example, by means of an internal optical tap or optical coupler provided in a manner well known in the art. The extracted portion of the signal may then be monitored and appropriate corrective action taken in the event that the signal falls outside a desired range of operation.

A disadvantage of the known techniques is that the use of a optical tap or coupler reduces the signal strength of the remaining optical signal, i.e., it is an addition of loss to the optical component. As a consequence, it has been proposed to gather some of the signal which is naturally lost from the waveguide by, for example, scattering within the LiNbO₃ chip. To achieve this goal, a photodiode has been arranged on the upper surface of the substrate or chip or on the output end face of the substrate. Unfortunately, these arrangements do not particularly work effectively, at least in part, because the power of the lost optical signal is very low and only a small part of the total lost light can be monitored because most of this scattered light goes into so-called substrate mode, where most of the light is scattered into and lost in the substrate. In any event, designers of such integrated optical component have attempted to reduce or minimize these scattering and other insertion losses from the waveguide which further reduces the total power of any scattered light in the substrate which might be available for photodetection component feedback control.

It is an object of this invention to provide a means through which more light lost from an optical signal propagating in a waveguide formed in a substrate and scattered into the substrate may be effectively utilized for the purposes of enhanced signal detection so that appropriate corrective action taken when the optical signal deviates from a desired range of operation.

### SUMMARY OF THE INVENTION

According to this invention, a packaged integrated optical component comprises a substrate or chip housed in the package and having an optical waveguide within which an optical signal propagates. A photodetector disposed relative to the waveguide collects light that leaks from or is lost from the waveguide and is scattered into the substrate. In particular, the photodetector is disposed below the waveguide or a plane of a lower surface of the substrate so that its field of detection for scattered light in the substrate bulk is sufficiently enhanced to provide for successful optical signal monitoring. More particularly, the photodetector positioned within the package integrated optical component is supported below the plane of the surface of the optical waveguide and in proximity to the substrate bulk lower surface or in a plane below the lower surface of the substrate within a region in proximity to the substrate lower surface.

Advantageously, embodiments of the present invention have benefited from investigations into alternative approaches to the collection of light lost from a waveguide in a substrate along which an optical signal is propagated to permit the monitoring of that light and overall control of the operation of the device. It had been found that the light scattered and lost generally downwardly from the optical waveguide, i.e. into the bulk of the substrate, can more easily be detected by a photodiode than the light scattered and lost upwardly and directed to the chip face from which the waveguide was formed or from the output or forward end face of the substrate. Thus, by detection of scattered light downwardly into the substrate improves the ability for detection of the propagating optical signal. Scattered light from the optical signal into the substrate and elsewhere is from optical losses due to the waveguide, but is especially true in the case when a device drives the light into the substrate with only a minimal optical output from the waveguide, such as, for example, extinction of the optical signal in the waveguide structure as occurs in the case of an optical component comprising a Mach-Zehnder modulator.

The photodetector may be comprised of a photodiode or other light detecting component, but the use of a photodetector will be primarily be used throughout the description. Such a photodiode may be supported below a lower surface of the substrate, but in proximity to the substrate's lower surface. A preferred position for the photodiode may be determined empirically during the manufacture of a prototype component of any given design, but once established for a component of that design, may remain substantially constant for that design so that automated manufacture on a production basis can be achieved.

Regardless of the preferred position for the photodiode, it is preferable that such a photodetector be located within the package of the optical component.

To accommodate the photodiode below the lower surface of the substrate, the base of the package in which the substrate is secured is provided with a recess to provide a place for the location of the photodiode. In another embodiment, the substrate may be mounted relative tot he package base by means of a substrate support having a sufficient thickness to accommodate the presence of the photodiode between the substrate and the base wall of the package.

In another embodiment, the photodiode may be conveniently mounted directly on the lower surface of the substrate or in a recess provided in the lower surface of the substrate, though it is also possible to mount the photodiode on the base of the package, adjacent to its lower surface of the substrate. Preferred mounting positions and arrangement may be determined empirically, at the time of prototyping of a design for a particular optical component.

The optical component may be passive optical component such as, for example, an optical coupler, a combiner or a splitter, or may be an active component such, for example, a modulator or wavelength converter provided that, in each case, there is sufficient light scattering from the optical signal propagating in the optical component is realized. In the case of an active component, the component may be provided with electrodes on the upper surface of the substrate that are driven with suitable electrical signals when the component is deployed, in an optical system or in an optical telecommunication system.

One such active optical component is a Mach-Zehnder optical modulator and tests have shown that the location of the photodiode below the output section of the waveguide formed in the substrate, such as a LiNbO₃ substrate or chip, between the second Y-junction of the interferometer and the output end plane of the chip, provides particularly good results. However, it has further been determined that satisfactory results may be obtained by locating the photodiode beyond the output end face of the substrate or chip adjacent the lower region of the lower portion of the substrate or substrate surface. This is believed to be the case because the light scattering is greater in a forward and downward direction, i.e., in a direction away from the upper surface of the substrate an its optical waveguide and towards the base of the package supporting the substrate, compared to other light scattering directions.

The various features of the present invention and its preferred embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF THE DRAWINGS

FIG. 1 is a schematic vertical sectional view through a first embodiment of this invention.

FIG. 2 is a schematic plan view of the embodiment shown in FIG. 1.

FIG. 3 is a plan view of a second embodiment of a component configured as a Mach-Zehnder interferometer.

FIG. 4 is a schematic side elevation of a third embodiment of this invention.

FIG. 5 is a plan view of the third embodiment of this invention shown in FIG. 4.

FIG. 6 is a schematic side elevation of a fourth embodiment of this invention.

FIG. 7 is a plan view of the fourth embodiment of this invention shown in FIG. 6.

### DETAILED DESCRIPTION OF THE INVENTION

Referring to FIG. 1, there is shown a vertical section through a part of a packaged integrated optical component 10 which may be, for example, a combiner, a splitter or an active component such as, for example, an electro-optical modulator. The packaged component 10 include a base 10A with side and end walls (not shown), and is covered with a top wall (not shown) which is sealed to the side and end walls under, for example, hermetically controlled conditions. The package for component 10 is typically machined from a block of metal forming a rigid base 10A. At the time of machining the metal block to form base 10A to support an optical component substrate or chip 11, a recess 12 is formed at a predetermined location along the length of the base.

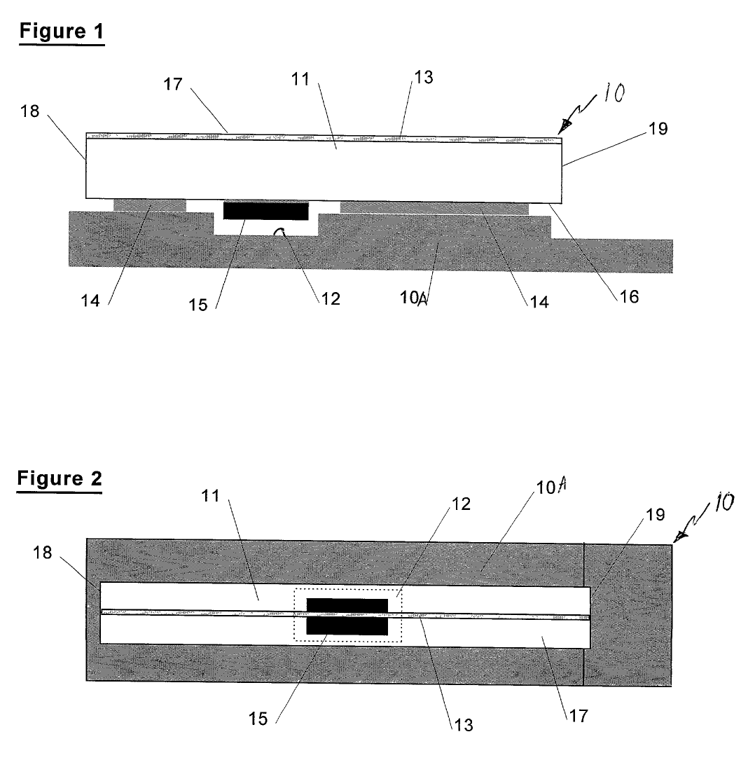

FIGS. 1 and 2 illustrate component substrate 11 in the form of a chip of lithium niobate cut from a wafer. Substrate 11 has formed in its surface an optical waveguide 13 by techniques well known and understood in the art. Briefly, the waveguide 13 may be formed by diffusion of a metal, such as titanium, into the lithium niobate so that the refractive index of the lithium niobate is changed within the area of diffusion.

The substrate 11 is mounted on base 10 of the component package by means of a chip attachment 14. Typically, this may comprise a resilient mount material which adheres to the undersurface of substrate 11 and to the upper face of base 10A. Alternatively, substrate 11 may be directly secured to the upper surface of package base 10A.

A photodiode 15 is secured to a lower surface 16 of substrate 11, i.e., the surface of substrate 11 opposite to upper surface 17 into which optical waveguide 13 has been diffused. The photodiode 15 is so secured prior to attachment of substrate 11 to package base 10A. Although, the required position for photodiode 15 should be determined empirically during prototyping of optical component 10, photodiode 15 is preferably disposed below waveguide 13 and partially along the length of the waveguide 13, between the input and output end faces 18, 19 of substrate 11. In an alternative arrangement (not shown), photodiode 15 may be secured directly to package base 10A within the recess 12 to provide a clearance between the upper face of photodiode 15 and the lower surface 16 of substrate 11.

By providing a photodiode 15 below a lower surface 16 of substrate 11, it has been discovered that photodiode 15 may collect a sufficient amount of scattered light in substrate 11 lost from waveguide 13 during operation of the component or device to permit adequate monitoring of the light propagating along waveguide 13. Furthermore, the collection of such light does not interfere with the normal operation of component 10.

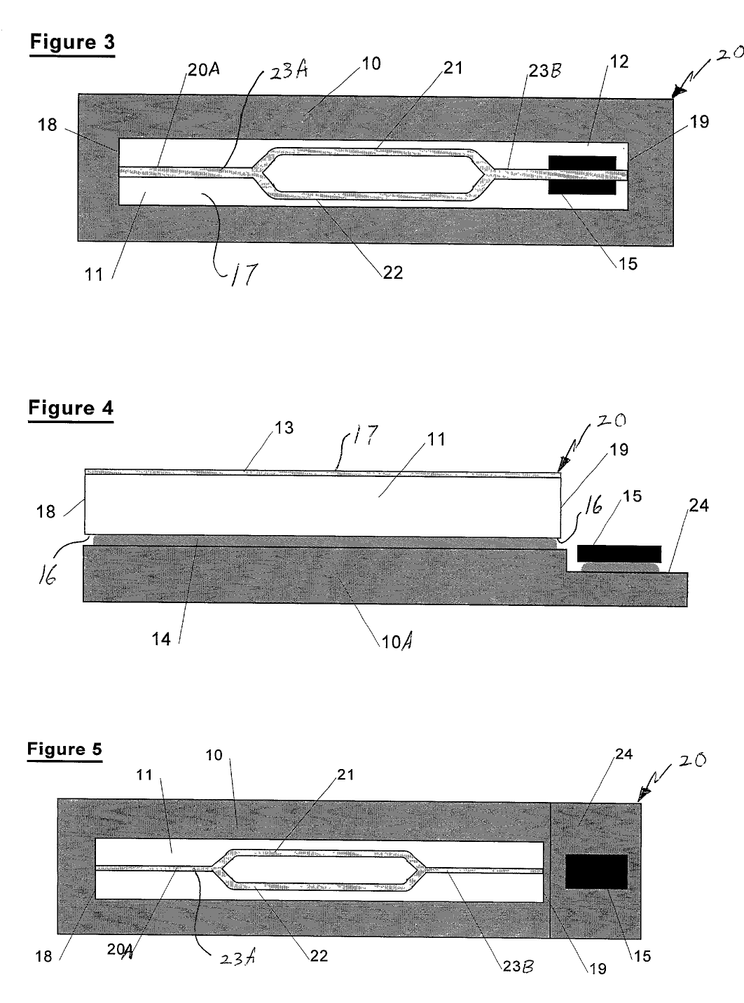

FIG. 3 shows a second embodiment illustrating an alternative possible waveguide configuration in lieu of linear optical waveguide 11 shown in FIG. 2. Referring to FIG. 3, component 20 comprises waveguide 20A has an input section 23A which splits into two branch waveguides 21, 22 that recombine into an output section 23B. Such an arrangement is well known in the art as Mach-Zehnder configuration. A suitable electrode structure (not shown) is subsequently formed on the upper surface 17 of substrate 11 in the vicinity of or in proximity of branch waveguides 21, 22 to influence the propagation of the light within the branch waveguides so that interference takes place on recombining of the light from the two branch waveguides in output section 23A, i.e., the light is modulated according to the driving signals applied to the electrodes as is well known in the art.

In the arrangement of FIG. 3, photodiode 15 is positioned below output section 23B to receive light scattered in the bulk of substrate 11 beneath that section, permitting monitoring of the modulated light leaving optical component 20. In the case here, however, recess 12 in the package base 10 is formed nearer output end face 19 of substrate 11 when mounted in the package, rather than at the position shown in FIG. 1, i.e., it is positioned to receive scattered modulated light from beneath substrate surface 16 at output end 19 of substrate 11. In all other respects, the arrangement employing the waveguide configuration of FIG. 3 is similar to that shown in FIGS. 1 and 2.

FIGS. 4 and 5 disclose a third embodiment of a packaged component 20 in which photodiode 15 is accommodated in yet another alternative position. Here, the photodiode 15 is disposed to one side of the substrate 11, that is, positioned outside the area of the substrate 11, beyond an output end face 19 of the substrate. To permit the positioning of the photodiode below the lower surface 16 of the substrate, a recess 24 is machined at a suitable location in the package base 10 as shown in FIG. 4. The photodiode 15 will receive light scattered into the substrate bulk from the waveguide 13 and exiting substrate 11 through substrate output end face 19.

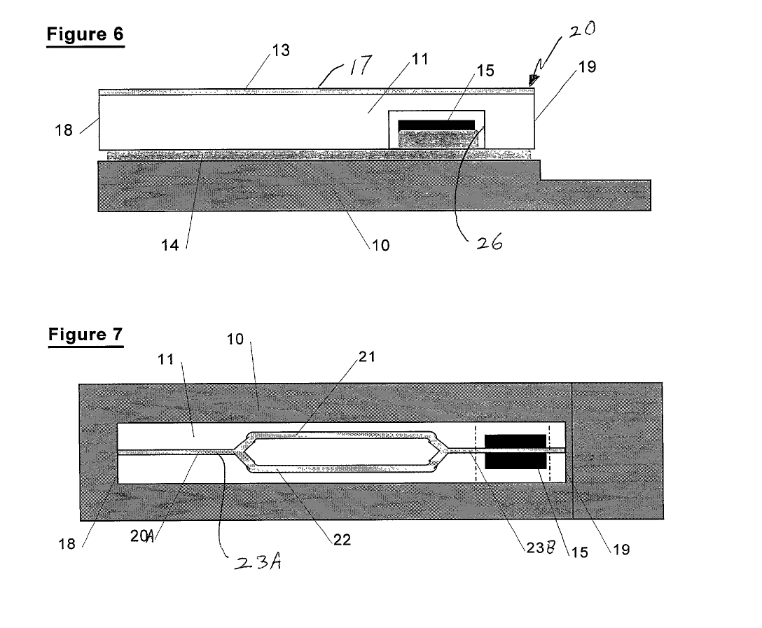

Referring to FIGS. 6 and 7 there is shown side sectional and plan views of a fourth embodiment of optical component 20 in which a lithium niobate substrate 11 has a recess 26 within its bottom surface to accommodate the positioning of photodiode 15. It can be appreciated that photodiode 15 is disposed beneath the output waveguide 23A and, accordingly, can collect and detect modulated light for the purposes of signal monitoring.

Although the above embodiments make reference to a “base” of a package, it will be appreciated by those skilled in the art that a “base” is a suitable surface upon which the substrate can be mounted.

Even though the above embodiments have been described with reference to the use of a single photodetector, the present invention is not limited to such arrangements. It will be appreciated that embodiments can be realized in which more than one photodetector may be employed in the several embodiments described. For example, two such photodiodes could be utilized in connection with any one recess 12, 24 or 26, or one photodiode may be utilized at one recess location and another utilized at another recess location. In each of these cases, the two photodiodes can be coupled together to provide a stronger detected monitoring signal for use in a system feedback arrangement for signal monitoring and correction.

Although the invention has been described in conjunction with one or more preferred embodiments, it will be apparent to those skilled in the art that other alternatives, variations and modifications will be apparent in light of the foregoing description as being within the spirit and scope of the invention. Thus, the invention described herein is intended to embrace all such alternatives, variations and modifications as that are within the spirit and scope of the following claims.

What is claimed is:

1. A packaged integrated optical component comprising:
a package having a base;
a substrate having an optical waveguide thereon;
said waveguide to receive an optical signal for propagation therealong wherein some of the signal light is lost into the substrate;
said substrate being mounted on the base of the package;
and at least one photodetector disposed below a plane of the waveguide and in proximity to the substrate to collect signal light scattered into the substrate from the waveguide.

2. The packaged integrated optical component according to claim 1 wherein the photodetector is disposed below a plane of a lower surface of the substrate.

3. The packaged integrated optical component according to claim 2 wherein the photodetector is supported below the lower surface of the substrate, within a region of the lower surface of the substrate.

4. The packaged integrated optical component according to claim 1 wherein the photodetector is mounted on a lower surface of the substrate.

5. The packaged integrated optical component according to claim 1 wherein the package base age is provided with a recess for accommodation of the photodetector when the photodetector is mounted on a lower surface of the substrate.

6. The packaged integrated optical component according to claim 1 wherein the substrate is mounted on the base of the package using a substrate support, and the substrate support is provided with a recess to accommodate the photodetector when the latter is mounted on a lower surface of the substrate.

7. The packaged integrated optical component according to claim 1 wherein a recess is formed in a lower surface of the substrate, the photodetector being mounted within the substrate recess.

8. The packaged integrated optical component according to claim 1 wherein an electrode structure is formed on a surface of the substrate to influence propagation of the signal light along the optical waveguide when the electrode structure is driven with a suitable control signal.

9. The packaged integrated optical component as claimed in claim 8 wherein the optical component comprises a Mach-Zehnder interferometer comprising two waveguide branches having first and second Y-junctions for coupling input and output sections respective to the two waveguide branches, the photodetector mounted below the waveguide output section.

10. The packaged integrated optical component according to claim 1 wherein the photodetector is mounted on the package base below a plane of a lower surface of the substrate.

11. The packaged integrated optical component according to claim 10 wherein the photodetector is arranged beyond an output end face of the substrate, outside a region of the lower surface of the substrate.

12. The packaged integrated optical component according to claim 10 wherein the base of the package is provided with a recess that accommodates the photodetector, the recess being outside a region of the lower surface of the substrate and adjacent to an output end face of the substrate.

13. The packaged integrated optical component according to claim 1 wherein the substrate is mounted on the base of the package using a substrate support, said substrate support beyond an end face of the substrate, the substrate support including a recess for mounting the photodetector so that the photodetector is positioned below the plane of a lower surface of the substrate.

14. The packaged integrated optical component according to claim 1 wherein the optical component comprises an active or passive optical component.

15. The packaged integrated optical component according to claim 14 wherein the optical component comprises Mach-Zehnder interferometer, Mach-Zehnder modulator, a wavelength converter, an optical coupler, an optical combiner or an optical splitter.

16. The packaged integrated optical component according to claim 1 wherein the substrate comprises a lithium niobate wafer or chip.

17. The packaged integrated optical component according to claim 1 wherein the photodetector comprises a photodiode.

18. The packaged integrated optical component according to claim 1 wherein a plurality of photodiodes are disposed below a plane of the waveguide in proximity to the substrate.
